(19) United States
(12) Patent Application Publication
(10) Pub. No.: US 2012/0159322 A1
(43) Pub. Date: Jun. 21, 2012

(54) GUI EVALUATION SYSTEM, METHOD AND PROGRAM

(75) Inventor: Teruya Ikegami, Minato-ku (JP)

(73) Assignee: NEC CORPORATION, Tokyo (JP)

(21) Appl. No.: 13/393,105

(22) PCT Filed: Jun. 7, 2010
(86) PCT No.: PCT/JP2010/003773

§ 371 Date: Feb. 28, 2012

(30) Foreign Application Priority Data
Aug. 31, 2009 (JP) 2009-200721

(51) Int. Cl. G06F 3/00

(52) U.S. Cl. 715/700

(57) ABSTRACT

A GUI evaluation system for evaluating GUI usability includes an operation load calculation unit which calculate a load value indicating a level of load of an operation based on attributes of UI components used for a GUI to be evaluated, and a confirmation suitability determination unit which determines suitability of a confirmation method related to the operation based on a load value calculated by the operation load calculation unit.

### TECHNICAL FIELD

The present invention relates to a GUI evaluation system, a GUI evaluation method and a GUI evaluation program for evaluating system usability.

### BACKGROUND ART

For GUI (Graphical User Interface), it is an important element of usability to confirm execution suitability with a user and to enable an operation to be cancelled before executing an important operation or time-consuming operation, particularly an operation which is difficult to recover once executed. However, if a confirmation is always made on operations which are not particularly important (are relatively easy to recover) or frequently-used operations, operability may be actually deteriorated.

Thus, a confirmation dialog does not need to be displayed for operations which are frequently used and are less important in consideration of a usage situation or business requirements of the actual system, but the usage situation or business requirements may not be necessarily grasped at any time. When the usage situation or business requirements are unclear, an importance of the operation is also unclear, and thus evaluator's discretion largely influences on a determination as to whether the confirmation dialog is to be displayed (is unnecessary) for the operation, and an objective determination cannot be made.

For example, in a GUI automatic evaluation device described in Patent Literature 1 as the first technique for usability evaluation, a screen design guide is input, rules accumulated as formal rules of the guide data are matched with attribute information and GUI information described as attribute values of GUI object data of a system to be evaluated per window, thereby outputting a match result with the rule per window. In addition, in patent Literature 1, means for generating GUI information based on a product specification or source, or a GUI construction tool is described.

In a test execution device described in Patent Literature 2 as the relevant second technique, when a test is executed, a user sequence designated by a user and a complementary sequence complemented for systematically executing the user sequence are held in an operation database. When the user sequence is executed according to the user sequence execution procedure, the state of the GUI is confirmed, and if possible, the user sequence is executed. On the other hand, if impossible, a proper complementary sequence is retrieved, and the user sequence is executed after executing the complementary sequence, thereby enabling a test for automatically executing a predefined operation procedure.

In a Web screen creation tool and a word check tool described in Patent Literature 3 as the relevant third technique, a Web screen source file is checked by use of spelling-fallible words such as previously registered homonyms, declensional kana ending and synonyms. When a registered word is detected on the Web screen to be evaluated, a list of alternatives to the word is displayed.

### CITATION LIST

### Patent Literature

PLT1: Patent 8-241191
PLT2: Patent 2004-110267
PLT3: Patent 2004-234402

### SUMMARY OF INVENTION

### Technical Problem

However, in the GUI automatic evaluation device described in Patent Literature 1, when a developing prototype, or a specification or source of other company's product cannot be obtained, GUI information needs to be manually described and the GUI information is difficult to correctly create. Even when the specification can be obtained, the specification itself may be erroneous and thus needs to be evaluated in an actually-operating system to be evaluated.

In the test execution device described in Patent Literature 2, a confirmation is only made as to whether the predefined user sequence has been normally executed, and the GUI or the sequence itself in the sequence execution cannot be evaluated. In the test execution device described in Patent Literature 2, a sequence needs to be prepared depending on the system to be evaluated.

In the Web screen creation tool and the word check tool described in Patent Literature 3, a property of usability other than non-registered words cannot be evaluated.

From the above, a typical GUI evaluation method has the following problems.

When a usage situation or business requirements of a system for which usability is to be evaluated are unclear, a determination cannot be objectively made as to whether a confirmation message is to be displayed (is unnecessary) for the operation. Even when the usage situation or business requirements of the system are clear, it is difficult to objectively determine whether the confirmation message is to be displayed.

This is because on a user's presumption of an importance of the operation for which the confirmation message is displayed, a determination that the confirmation message is to be displayed needs to be made when the importance is determined as being high, but an objective and common reference is not present as a threshold for an operation importance calculation method or a determination reference as to whether to display the confirmation message, and is defined at evaluator's discretion.

Further, even when the evaluator grasps the importance of the operation for which the confirmation message is displayed, a level of the importance is only roughly recognized as high or low, and a clear reference as to whether to display the confirmation message is not defined. Consequently, the suitability determination depends on evaluator's discretion.

It is therefore an object of the present invention to provide a GUI evaluation system, a GUI evaluation method and a GUI evaluation program capable of objectively determining suitability of a confirmation message to be displayed in GUI evaluation.

### Solution to Problem

A GUI evaluation system according to the present invention is directed for evaluating GUI usability and comprises operation load calculation means for calculating a load value indicating a level of load of operation based on attributes of UI components used for a GUI to be evaluated, and confirmation suitability determination means for determining suitability of a confirmation method related to the operation based on a load value calculated by the operation load calculation means.

A GUI evaluation method according to the present invention is directed for evaluating GUI usability and comprises calculating a load value indicating a level of load of operation based on attributes of UI components used for a GUI to be evaluated, and determining suitability of a confirmation method related to the operation based on a calculated load value.

A GUI evaluation program according to the present invention is directed for evaluating GUI usability, and causes a computer to perform a load value calculation processing of calculating a load value indicating a level of load of operation based on attributes of UI components used for a GUI to be evaluated, and a suitability determination processing of determining suitability of a confirmation method related to the operation based on a calculated load value.

### Advantageous Effects of Invention

According to the present invention, suitability of a confirmation message to be displayed can be objectively determined in GUI evaluation.

### BRIEF DESCRIPTION OF DRAWINGS

FIG. 1 is a block diagram showing an exemplary GUI evaluation system structure according to the present invention;

FIG. 2 is a flow diagram showing exemplary processings executed by an operation load calculation unit 3;

FIG. 3 is an explanatory diagram showing an exemplary screen used for operation;

FIG. 4 is an explanatory diagram showing an exemplary screen used for operation;

FIG. 5 is an explanatory diagram showing an exemplary screen used for operation;

FIG. 6 is an explanatory diagram showing an exemplary screen used for operation;

FIG. 7 is an explanatory diagram showing an exemplary screen used for operation;

FIG. 8 is an explanatory diagram showing an exemplary screen used for operation;

FIG. 9 is a block diagram showing an exemplary GUI evaluation system structure according to a second exemplary embodiment;

FIG. 10 is an explanatory diagram showing an exemplary screen for designating component information output from a component information input unit 201 to input/output means 1;

FIG. 11 is a block diagram showing an exemplary GUI evaluation system structure according to a third exemplary embodiment;

FIG. 12 is an explanatory diagram showing an exemplary determination map by an importance (load value) and an operation frequency held in a confirmation level determination unit 401;

FIG. 13 is an explanatory diagram showing an exemplary confirmation dialog with the highest confirmation level; and

FIG. 14 is a block diagram showing an exemplary smallest structure of the GUI evaluation system.

### DESCRIPTION OF EMBODIMENTS

### First Exemplary Embodiment

A first exemplary embodiment of the present invention will be described below with reference to the drawings. The feature of the present exemplary embodiment is that a GUI evaluation system includes an operation load calculation unit 3 and a confirmation suitability determination unit 4. The operation load calculation unit 3 calculates a load value indicating a level of load of operation on a user, based on a type or the number of UI components or screens used for an operation designated by an evaluator's operation, and outputs it to the confirmation suitability determination unit 4. The confirmation suitability determination unit 4 assumes a load value output from the operation load calculation unit 3 as an importance of the operation, and determines suitability for displaying a confirmation message for the operation based on whether the load value exceeds a predetermined threshold, and outputs the determination result to input/output means 1.

In the present exemplary embodiment, a person who actually uses a system to be evaluated is referred to as user, and a person who uses the GUI evaluation system to evaluate a system to be evaluated is referred to as evaluator.

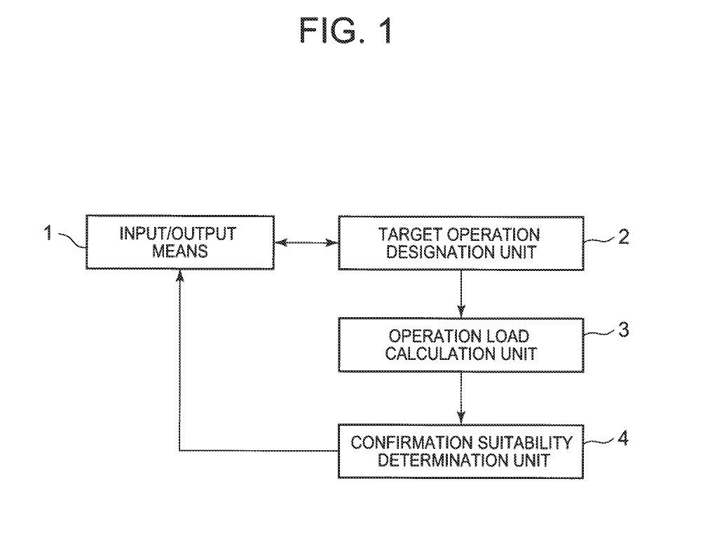

FIG. 1 is a block diagram showing an exemplary GUI evaluation system structure according to the present exemplary embodiment. As shown in FIG. 1, the GUI evaluation system according to the first exemplary embodiment of the present invention includes the input/output means 1, a target operation designation unit 2, the operation load calculation unit 3 and the confirmation suitability determination unit 4. The GUI evaluation system is achieved by an information processing device such as personal computer operating according to a program.

The input/output means 1 is specifically achieved by an input device such as mouse or keyboard, and an output device such as display device. The input/output means 1 comprises a function of inputting information according to an input operation using the input device by an evaluator, and a function of outputting information to the output device.

The target operation designation unit 2 is specifically achieved by a CPU of an information processing device operating according to a program. The target operation designation unit 2 comprises a function of specifying an operation for which an importance is to be calculated as a set of screens or UI components based on input information input by the input/output means 1 according to an evaluator's operation, and of outputting a specified set of screens or UI components as information on one (designated) operation to the operation load calculation unit 3.

The operation load calculation unit 3 is specifically achieved by a CPU of the information processing device operating according to a program. The operation load calculation unit 3 comprises a function of extracting all the screens and UI components used for an operation with reference to information on the operation output from the target operation designation unit 2. The operation load calculation unit 3 comprises a function of determining a load value of the UI component per UI component in each extracted screen based on a type of the UI component (such as text box, list box, radio button), and a property of the UI component (such as the number of rows of text box, a presence of a neighboring reference button, the number of items of list box and the number of options of radio button). The operation load calculation unit 3 comprises a function of calculating the sum of the load values of the UI components included on the same screen as a load value of the operation executed on the screen.

The operation load calculation unit 3 may calculate a load value in consideration of a hierarchy relationship among the screens. For example, when multiple screens used for the operation are present and the screens are in a hierarchy relationship, the operation load calculation unit 3 adds (or multiplies) a predetermined weight to a load value of a screen at a deep hierarchy, and then calculates the sum of the load values of all the screens (or the UI components) used for the operation as a load value of the operation, and output it to the confirmation suitability determination unit 4.

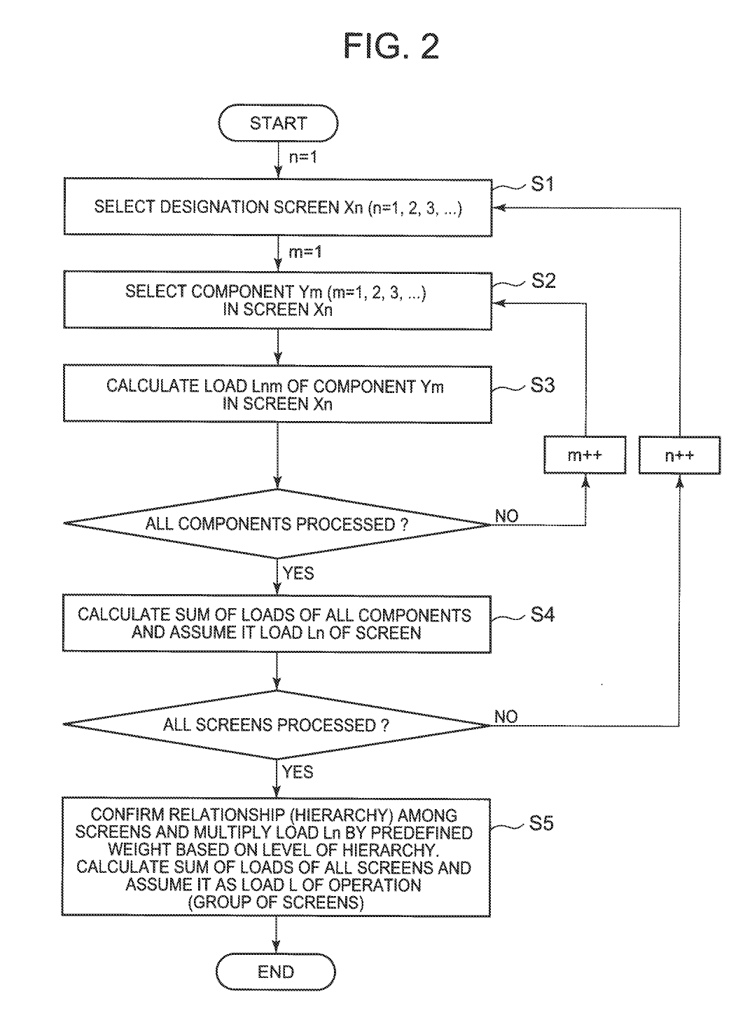

FIG. 2 is a flow diagram showing exemplary processings executed by the operation load calculation unit 3.

In order to evaluate GUI usability, the evaluator uses the input/output means 1 to execute an operation of designating a group of screens Xn (n=1, 2, 3, . . . ) as an operation to be evaluated. Then, the target operation designation unit 2 designates the group of screens Xn (n=1, 2, 3, . . . ) according to the evaluator's operation, and outputs the designated group of screens Xn (n=1, 2, 3, . . . ) to the operation load calculation unit 3.

Then, the operation load calculation unit 3 selects an optional screen X1 from the group of screens Xn (n=1, 2, 3, . . . ) designated by the target operation designation unit 2 (step S1).

Then, the operation load calculation unit 3 selects a UI component Y1 from a group of UI components Ym (m=1, 2, 3, . . . ) included in the selected screen X1 (step S2).

Then, the operation load calculation unit 3 refers to a property of the UI component based on the type of the selected UI component Y1, and calculates a load value L11 of the UI component Y1 (step S3).

For example, it is assumed that the type of the selected UI component is a text box. In this case, the operation load calculation unit 3 confirms the properties such as whether the number of rows or an initial value is previously input, whether an input type (such as alpha-numeric and Japanese) is controlled on focus, or whether a “reference” button or “calendar” button is present to the right of or immediately below the text box, with reference to a predefined load value Lt set for a typical text box (such as the number of rows is one, the initial state is null, and free input is possible). Then, the operation load calculation unit 3 adds, subtracts or multiplies a predefined weight to, from or by the predefined load value Lt to calculate the load value L of the UI component.

The operation load calculation unit 3 calculates the load value to be 5 Lt (five times the reference value) in the case of a 5-row text box, and calculates the load value to be 0.8 Lt in the case of an one-row text box with a “reference” button sideways.

When the type of the UI component is a list box, if the number of selectable items is too many, a load value to be set is larger than the predefined load value L1 (less than Lt) set for a typical list box.

The reference load values are similarly defined also for other UI components such as radio button, check box and operation button, and the operation load calculation unit 3 calculates a load value of a UI component with reference to a property of each similarly-predefined UI component type. The predefined load values are previously registered by a system manager, for example. The predefined load values are registered and updated by the evaluator in evaluating GUI usability, for example.

Then, the operation load calculation unit 3 determines whether the load values of all the UI components included in the screen selected in step S1 have been calculated. Then, when determining that the load values of all the UI components have not been calculated, the operation load calculation unit 3 advances the processing to step S2. Thereafter, until determining that the load values of all the UI components included in the screen selected in step S1 are calculated, the operation load calculation unit 3 repeats the processings in steps S2 to S3.

Then, the operation load calculation unit 3 calculates the sum of the load values L1m of the group of all UI components Ym (m=1, 2, 3, . . . ) included in the screen X1 as the load value L of the screen X1 (step S4).

Then, the operation load calculation unit 3 determines whether the load values of all the screens used for the designated operation have been calculated. When determining that the load values of all the screens have not been calculated, the operation load calculation unit 3 advances the processing to step S1.

Thereafter, the operation load calculation unit 3 executes the above processings (steps S1 to S4) on the group of all screens Xn (n=1, 2, 3, . . . ) used for the designated operation, and calculates the load value Ln of each screen.

Then, when a hierarchy relationship is present among the screens (such as when there is present a screen which is called in response to a user operation of pressing a button in an optional screen in the designated group of screens), the operation load calculation unit 3 adds or multiplies a predefined weight depending on the depth of the hierarchy to calculate the load value of the screen. Thereafter, the operation load calculation unit 3 calculates the sum of the load values of the group of all designated screens Xn (n=1, 2, 3, . . . ) as the load value L of the operation (step S5).

For example, the screen X2 which is called in response to a user operation of pressing a “details” button included in the screen X1 is at the hierarchy level of 2. Thus, the operation load calculation unit 3 calculates the value αL2 obtained by multiplying the load value L2 of the screen calculated from the UI component included in the screen X2 by the hierarchy weight a as the predefined weight depending on the depth of the hierarchy to be the final load value. The hierarchy weights are previously registered by a system manager, for example. The hierarchy weights are registered and updated by the evaluator in evaluating GUI usability, for example.

The confirmation suitability determination unit 4 refers to the load value of the operation output from the operation load calculation unit 3 to assume the load value as an importance of the operation, and determines whether the importance exceeds a predetermined threshold. When the threshold is not exceeded, the confirmation suitability determination unit 4 determines that to display the confirmation message is an excessive confirmation processing (problematic), and outputs the determination result to the input/output means 1. In the present exemplary embodiment, the operation load calculation unit 3 calculates a load value of an operation thereby to calculate an importance of the operation to be evaluated.

The confirmation suitability determination unit 4 may add or multiply a predefined weight depending on operation contents to or by the load value of the operation output from the operation load calculation unit 3 and may assume it as an index of the importance with reference to information indicating the operation contents (such as file deletion operation and edition operation cancellation). For example, the confirmation suitability determination unit 4 uses a weight coefficient as the weight for calculation.

There will be described below, as an exemplary operation of the present exemplary embodiment, a flow in which the operation load calculation unit 3 and the confirmation suitability determination unit 4 calculate a load value of a screen used for an operation to be evaluated designated according to an evaluator's operation, and determine whether to display a confirmation message based on the calculated load value.

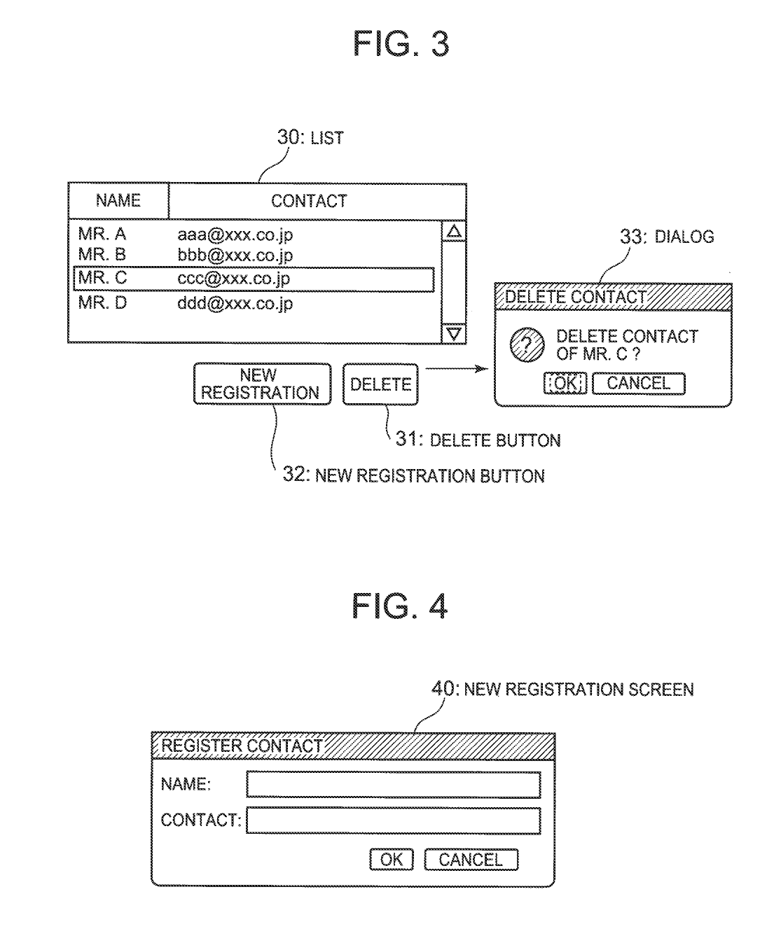

FIG. 3 is an explanatory diagram showing an exemplary screen used for operation. In a list 30 shown in FIG. 3, when the user presses a “delete” button 31 for a selected row, a confirmation dialog 33 is displayed.

In this case, the evaluator uses the input/output means 1 to designate a new registration screen 40 (FIG. 4) to be called in response to a user's operation of pressing a “new registration” button 32 for recovering (re-inputting) the row to be deleted in the list 30 as an operation corresponding to the confirmation dialog 33 in order to evaluate the operation (a processing of displaying the confirmation dialog 33 or a data deletion processing) executed by pressing the “delete” button 31.

Then, the target operation designation unit 2 designates an operation of pressing the “new registration” button 32 as an operation corresponding to the operation of pressing the “delete” button 31 according to an evaluator's operation.

Then, the operation load calculation unit 3 calculates the load values of a text box “name” and a text box “contact” which are the UI components included in the new registration screen 40 designated as the operation by the target operation designation unit 2.

In the example shown in FIG. 4, since any text box has one row and is of a typical type, the operation load calculation unit 3 may calculate a predefined load value “10” preset for the text box as the load value of each UI component.

Further, the operation load calculation unit 3 calculates a value “20” obtained by adding the load values of the two text boxes as the load value of the new registration screen 40. Then, the operation load calculation unit 3 outputs the calculated load value as the load value of the operation to the confirmation suitability determination unit 4.

Then, the confirmation suitability determination unit 4 assumes the load value “20” of the operation output from the operation load calculation unit 3 as an index indicating an importance of an item to be confirmed by the confirmation dialog 33, and compares it with a predetermined threshold “50.” Since the load value is less than the predetermined threshold, the confirmation suitability determination unit 4 determines that the confirmation dialog 33 is displayed for the operation with a less importance and that it is problematic, and outputs the determination result to the input/output means 1. Thereafter, the input/output means 1 is controlled to display the determination result on the display device, for example.

As described above, in the present exemplary embodiment, the target operation designation unit 2 designates an operation (screen) for recovering (re-inputting) the same data in order to determine whether the confirmation dialog displayed in deleting data is unnecessary. Then, the operation load calculation unit 3 calculates a load value of the designated operation. Then, the confirmation suitability determination unit 4 assumes the calculated load value as an index indicating an importance of an item to be confirmed by the confirmation dialog, and determines whether the confirmation dialog 33 is unnecessary based on whether the predefined threshold is exceeded. Thus, an objective determination can be made without evaluator's discretion.

There will be described below, as another exemplary operation of the present exemplary embodiment, a flow in which the operation load calculation unit 3 and the confirmation suitability determination unit 4 calculate a load value of a screen used for an operation to be evaluated according to an evaluator's operation and determine whether to display a confirmation message based on the calculated load value.

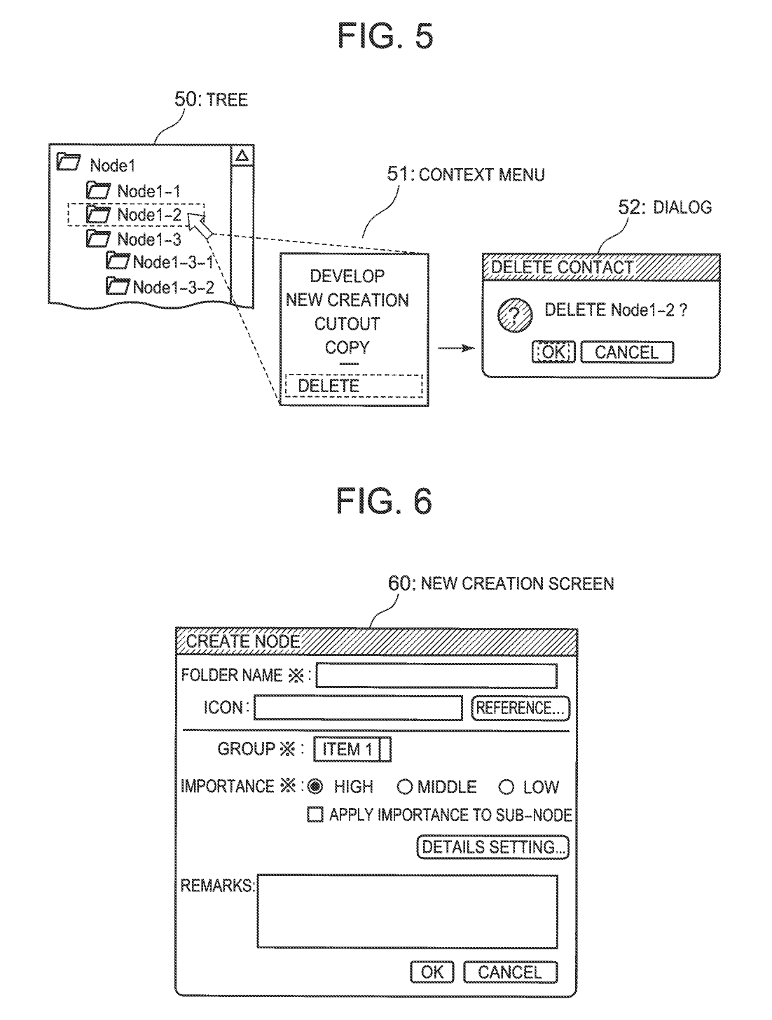

FIG. 5 is an explanatory diagram showing an exemplary screen used for operation. In a tree 50 shown in FIG. 5, when the user selects “delete” in a displayed context menu 51 for a selected node, a confirmation dialog 52 is displayed.

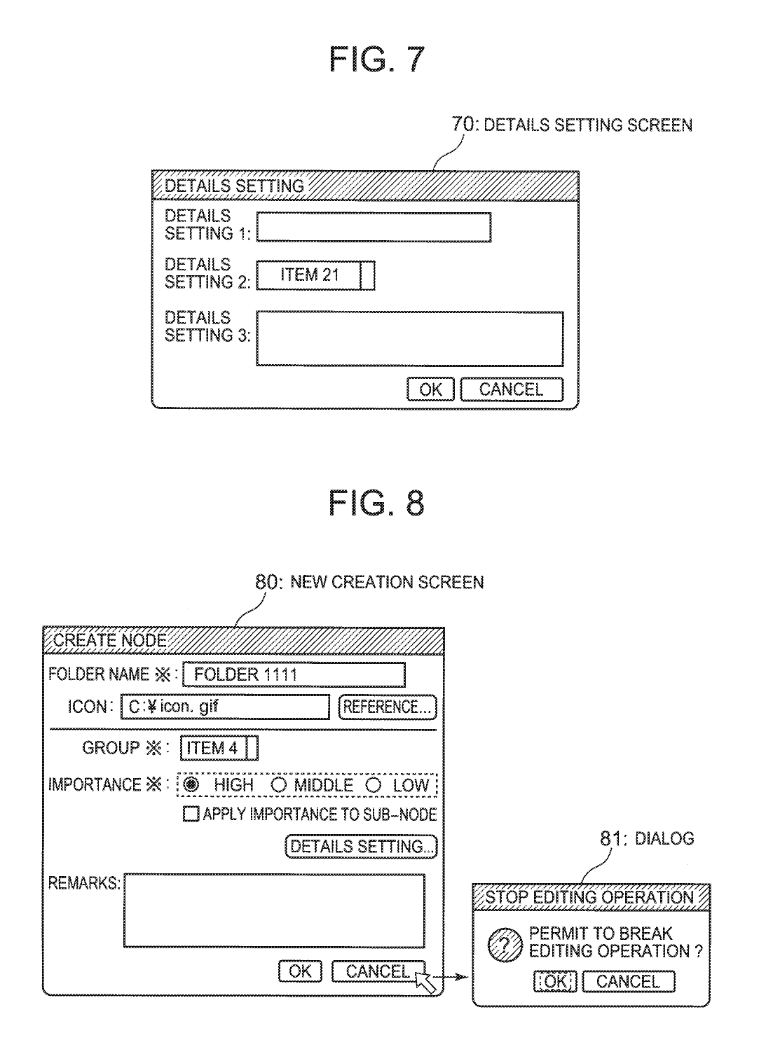

To the contrary, the operation of recovering (re-inputting) a node to be deleted in the tree 50 includes a new creation screen 60 (FIG. 6) to be called when the user presses “new creation” in the context menu 51 and a details setting screen 70 (FIG. 7) to be called when the user presses a “details setting” button in the new creation screen 60.

In this case, the evaluator uses the input/output means 1 to designate the new creation screen 60 and the details setting screen 70 as the operations for the confirmation dialog 52.

Then, the target operation designation unit 2 designates the new creation screen 60 and the details setting screen 70 as the operations for the confirmation dialog 52 according to an evaluator's operation.

Then, the operation load calculation unit 3 calculates the load values of the group of UI components included in the new creation screen 60, respectively. A text box “folder name” shown in FIG. 6 is typical. The operation load calculation unit 3 calculates the predefined load value “10” preset for the text box as the load value of the text box “folder name.”

To the contrary, a text box “icon” is of one row, but comprises a “reference” button as a means other than direct input means sideways. Thus, the operation load calculation unit 3 calculates the value “8” obtained by multiplying the predefined load value “10” by the weight “0.8” as the load value of the text box “icon.”

A text box “remarks” shown in FIG. 6 has five rows. Thus, the operation load calculation unit 3 calculates the value “50” obtained by multiplying the predefined load value “10” by the weight “5” as the load of the text box “remarks.”

A list box “group” shown in FIG. 6 has five selectable items. Thus, assuming a typical list box, the operation load calculation unit 3 calculates the predefined load value “5” preset for the list box as the load value of the list box “group.”

The radio button “importance” shown in FIG. 6 has three selectable items. Thus, assuming a typical radio button, the operation load calculation unit 3 calculates the load value “3” preset for the radio button as the load value of the radio button “importance.”

A check box “apply importance to sub-node” shown in FIG. 6 has one item. Assuming a typical check box, the operation load calculation unit 3 calculates the predefined load value “2” preset for the check box as the load value of the check box “apply importance to sub-node.”

Then, the operation load calculation unit 3 calculates the sum of the load values calculated for the UI components of 78 (10+8+50+5+3+2) as the load value of the new creation screen 60.

The operation load calculation unit 3 similarly calculates the load values of the group of UI components included in the details setting screen 70, respectively.

A text box “details setting 1” shown in FIG. 7 is typical. Thus, the operation load calculation unit 3 calculates the predefined load value “10” preset for the text box as the load value of the text box “details setting 1.”

A text box “details setting 3” shown in FIG. 7 has three rows. The operation load calculation unit 3 calculates the value “30” obtained by multiplying the predefined value “10” by the weight “3” as the load value of the text box “details setting 3.”

A list box “details setting 2” shown in FIG. 7 has 20 selectable items. Assuming that the selection operation is more time-consuming than a typical list box, the operation load calculation unit 3 calculates the value “10” obtained by multiplying the predefined load value “5” preset for the list box by the weight “2” as the load value of the list box “details setting 2.”

Then, the operation load calculation unit 3 calculates the value “60” obtained by multiplying the sum of the load values calculated for the UI components of 50(10+30+10) by the weight “1.2” considering a hierarchy level of the details setting screen 70 (deeper by one hierarchy than the new creation screen 60) as the load value of the details setting screen 70.

Further, the operation load calculation unit 3 outputs the sum of the load values of the new creation screen 60 and the details setting screen 70 of 138(78+60) as the load value of the designated operations to the confirmation suitability determination unit 4.

The confirmation suitability determination unit 4 assumes the load value “138” of the operation output from the operation load calculation unit 3 as an index indicating an importance of an item to be confirmed by the confirmation dialog 52, and compares it with the predetermined threshold 50. Since the load value is larger than the predetermined threshold, the confirmation suitability determination unit 4 assumes that the confirmation dialog 52 is displayed for the operation with a high importance, determines that it is not problematic, and outputs the determination result to the input/output means 1. Thereafter, the input/output means 1 is controlled to display the determination result on the display device, for example.

As described above, in the exemplary operation, the target operation designation unit 2 designates operations (group of screens) for recovering (re-inputting) the same data in order to determine whether the confirmation dialog to be displayed in deleting data is unnecessary. The operation load calculation unit 3 calculates the load value of the operation in consideration of the hierarchy structure of the designated screens. The confirmation suitability determination unit 4 assumes the calculated load value as an index indicating an importance of an item to be confirmed by the confirmation dialog, and determines whether the confirmation is unnecessary based on whether the load value exceeds the predetermined threshold. Thereby, an objective determination can be made without evaluator's discretion.

There will be described below, as another exemplary operation of the present exemplary embodiment, a flow in which the operation load calculation unit 3 and the confirmation suitability determination unit 4 calculate a load value of a screen used for an operation designated according to an evaluator's operation, and determines whether to display a confirmation message based on the calculated load value.

As shown in FIG. 8, in a new creation screen 80 (the same as the new creation screen 60 of FIG. 6), when the user presses a “cancel” button for interrupting an operation, a confirmation dialog 81 is displayed.

In this case, the evaluator uses the input/output means 1 to designate the new creation screen 80 as the operation corresponding to the confirmation dialog 81, which is the operation to be discarded by user's pressing a “cancel” button.

The target operation designation unit 2 designates the new creation screen 80 as the operation corresponding to the confirmation dialog 81 according to an evaluator's operation.

Then, the operation load calculation unit 3 calculates the load values of the group of UI components included in the new creation screen 80 designated by the target operation designation unit 2. Similar to the above example, the operation load calculation unit 3 calculates the load value “78” of the new creation screen 80, and outputs it as the load value of the operation to the confirmation suitability determination unit 4.

The confirmation suitability determination unit 4 assumes the load value “78” of the operation output from the operation load calculation unit 3 as an index indicating an importance of an item to be confirmed by the confirmation dialog 81, and compares it with the predetermined threshold “50.” Since the load value is larger than the predetermined threshold, the confirmation suitability determination unit 4 assumes that the confirmation dialog 81 is displayed for the operation with a high importance, determines that it is not problematic, and outputs the determination result to the input/output means 1. Thereafter, the input/output means 1 is controlled to display the determination result on the display device, for example.

As described above, in the exemplary operation, the target operation designation unit 2 designates the operation (screen) for inputting the data to be discarded in order to interrupt the operation and determine whether the displayed confirmation dialog is unnecessary in discarding the operation. The operation load calculation unit 3 calculates the load value of the designated operation. The confirmation suitability determination unit 4 assumes the calculated load value as an index indicating an importance of an item to be confirmed by the confirmation dialog, and determines whether the confirmation is unnecessary based on whether the predetermined threshold is exceeded. Thereby, an objective determination can be made without evaluator's discretion.

The predefined load value or weight value and the calculation method per UI component exemplified in the present exemplary embodiment may be other value or calculation method (such as multiplication instead of addition).

When the target operation designation unit 2 designates an operation according to an evaluator's operation, the contents to be confirmed (such as confirmation for data deletion and confirmation for operation discard) can be designated, and the confirmation suitability determination unit 4 may hold a different threshold per content to be confirmed, and make a determination.

When designating an operation according to an evaluator's operation, the target operation designation unit 2 may designate in units of UI component in a screen, for example, instead of in units of screen.

In the present exemplary embodiment, the screen or GUI component used for the operation can be designated by the target operation designation unit 2, and suitability of the confirmation method is determined with reference to the designated screen or GUI component according to an evaluator's operation, but information for specifying an operation to be evaluated may be previously held and referred to by the operation load calculation unit 3 instead of the provision of the target operation designation unit 2.

As described above, by use of the GUI evaluation system according to the present exemplary embodiment, a load of the operation on the user is calculated for the operation designated in units of screen or UI component by the evaluator based on the type or the number of screens or UI components used for the designated operation, and is assumed as an importance of the operation to determine whether the load value exceeds the predetermined threshold.

Consequently, even when the usage situation or business requirements are unclear, a determination can be objectively made as to whether to display an execution confirmation message on data deletion or any operation cancellation without evaluator's discretion. In other words, the evaluator can evaluate GUI usability based on a predetermined reference.

### Second Exemplary Embodiment

A second exemplary embodiment of the present invention will be described below. The present exemplary embodiment is such that the target operation designation unit 2 comprises a component information input unit 201 and the operation load calculation unit 3 comprises a component information processing unit 301 in addition to the structure of the first exemplary embodiment.

The component information input unit 201 comprises a function of outputting component information indicating a necessity of input, an operation frequency or a necessity of business knowledge at input to the operation load calculation unit 3 in association with each UI component used for the designated operation according to an evaluator's designation operation.

The component information processing unit 301 comprises a function of calculating a load value of a UI component with reference to component information associated with each UI component output from the component information input unit 201.

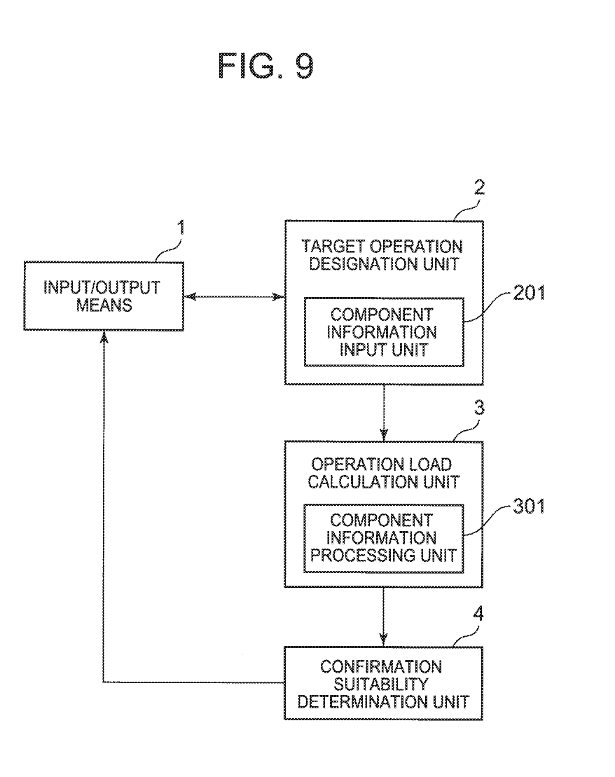

FIG. 9 is a block diagram showing an exemplary GUI evaluation system structure according to the present exemplary embodiment. Only the constituents different from those in the first exemplary embodiment will be described below.

The component information input unit 201 comprises a function of adding information on usage situation and business requirements such as a necessity of input, an operation frequency or a necessity of business knowledge at input to each UI component used for the designated operation based on the information input from the input/output means 1 according to an evaluator's operation, and outputting it as component information to the operation load calculation unit 3.

The component information processing unit 301 calculates a load value of a UI component with reference to the component information associated with each UI component output from the component information input unit 201.

There will be described below, as an exemplary operation of the present exemplary embodiment, a flow in which component information is designated per UI component used for a designated operation, a load value is calculated with reference to the component information, and a determination is made as to whether to display a confirmation message based on the calculated load value.

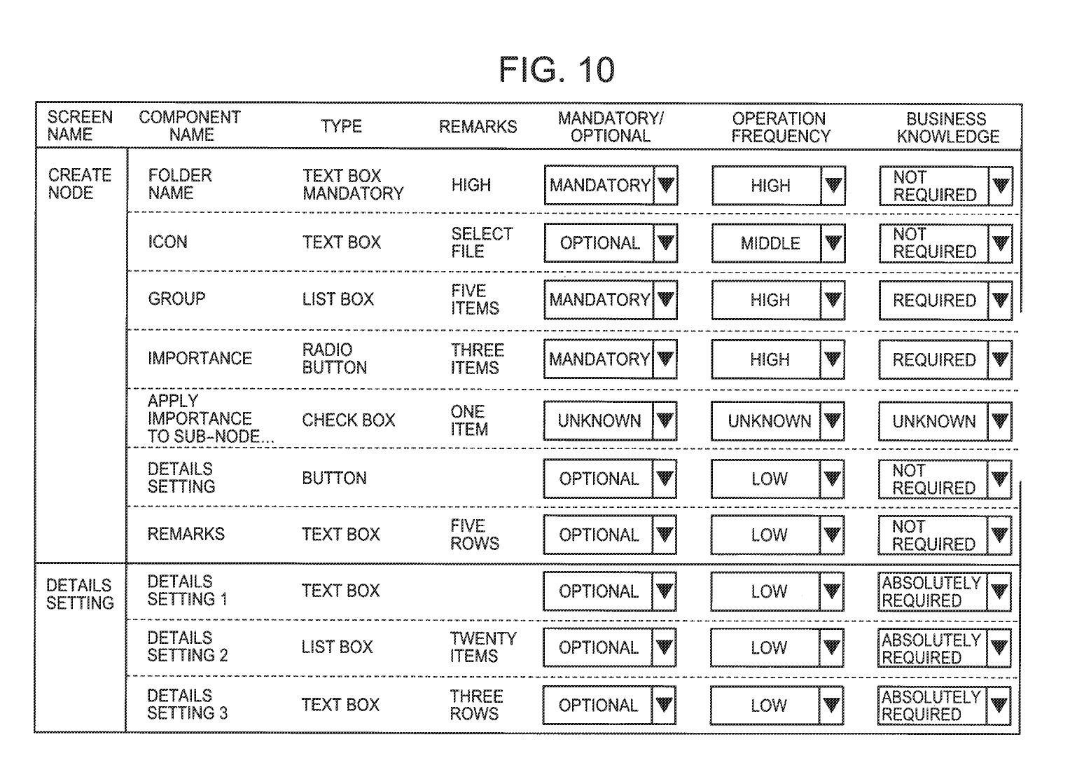

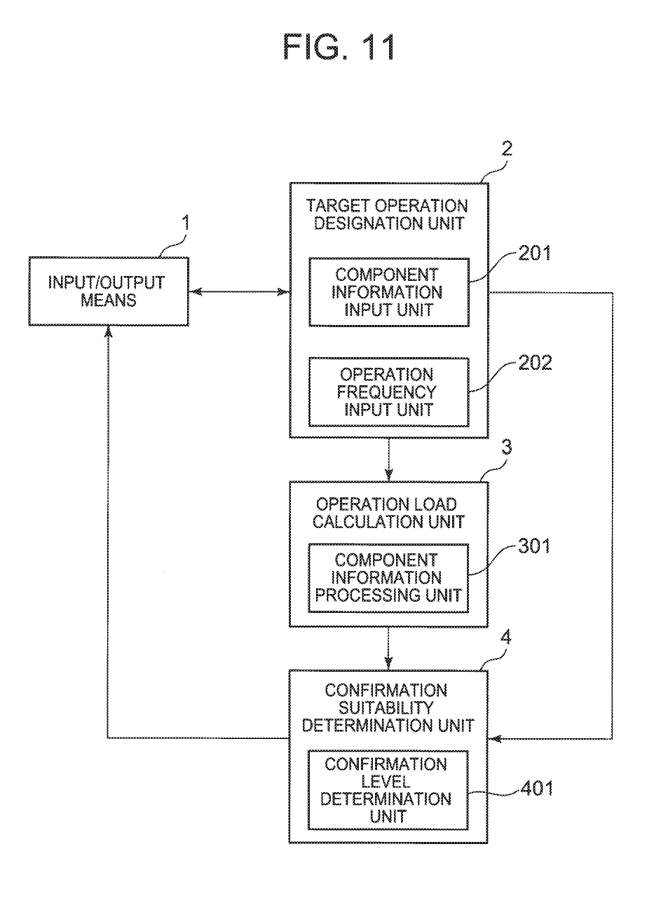

FIG. 10 is an explanatory diagram showing an exemplary screen for designating component information output from the component information input unit 201 to the input/output means 1.

The exemplary screen shown in FIG. 10 is related to the new creation screen 60 (FIG. 6) and the details setting screen 70 (FIG. 7) introduced in the first exemplary embodiment. As shown in FIG. 10, in the exemplary screen, information readable from the screen information to be evaluated such as screen name, component name, component type and property can be displayed, and additionally items for usage situation and business requirements such as mandatory/optional of input of each UI component, an operation frequency, a necessity of business knowledge at input can be designated.

In the example shown in FIG. 10, the text box “folder name” included in a “create node” screen (the new creation screen 60) must be input, and is designated as business knowledge not required at input.

The text box “icon” does not have to be input, but is designated at operation frequency of middle (not low). For a check box “apply importance to sub-node”, the evaluator does not hold the information on the UI component and thus all the component information is unclear.

The operation of the GUI evaluation system according to the second exemplary embodiment will be described below. In order to evaluate GUI usability, the evaluator uses the input/output means 1 to designate an operation, and inputs component information on all UI components of a screen used for the operation in a user-graspable range.

The component information input unit 201 inputs component information on all the UI components according to an evaluator's operation, and outputs the input component information to the operation load calculation unit 3.

Then, the operation load calculation unit 3 calculates the load values of the group of UI components included in the new creation screen 60, respectively. At this time, the component information processing unit 301 corrects the load value of each UI component with reference to the component information output from the component information input unit 201.

The text box “folder name” is typical. Thus, assuming the load value “10” preset for the text box, the component information processing unit 301 multiplies it by the input-mandatory predefined weight “1”, and further multiplies it by the predefined weight “1” due to unnecessary business knowledge to consequently correct the load value to “10.”

The text box “icon” has one row, but comprises a “reference” button as a means other than direct input sideways. Thus, the component information processing unit 301 multiplies the predefined load value “10” by the weight “0.8”, and further multiplies it by the predefined weight “0.5” with optional input and middle operation frequency. The component information processing unit 301 multiplies it by the predefined weight “1” due to unnecessary business knowledge, and consequently corrects the load value to 4.

The text box “remarks” has five rows. Thus, the component information processing unit 301 multiplies the predefined load value “10” by the weight “5”, and further multiplies it by the predefined weight “0” due to optional input and low operation frequency to consequently correct the load value to 0.

The list box “group” has five selectable items. Thus, assuming a typical list box, the component information processing unit 301 assumes the load value “5” preset for the list box, and multiplies it by the predefined weight “1” due to mandatory input. The component information processing unit 301 multiplies the load value by the predefined weight “1.5” due to necessary business knowledge, and consequently corrects the load value to “7.5.”

The radio button “importance” has three selectable items. Thus, assuming a typical radio button, the component information processing unit 301 assumes the load value “3” preset for the radio button, and further multiplies it by the predefined weight “1” due to mandatory input. The component information processing unit 301 multiplies the load value by the predefined weight “1.5” due to necessary business knowledge, and consequently corrects the load value to “4.5.”

The check box “apply importance to sub-node” has one item. Thus, assuming a typical check box, the component information processing unit 301 assumes the load value “2” set for the check box, and further multiplies it by the predefined weight “1” due to unclear input necessity or frequency to consequently correct the load value to “2”.

Then, the operation load calculation unit 3 calculates the sum of the load values calculated for the respective components of 28(10+4+7.5+4.5+2) as the load value of the new creation screen 60.

The operation load calculation unit 3 similarly calculates the load values of the group of UI components included in the details setting screen 70, respectively. Since all the UI components of the details setting screen 70 are input-optional and low operation frequency, the component information processing unit 301 multiplies the load value by the predefined weight “0” to correct the load values of all the UI components to “0.” Consequently, the operation load calculation unit 3 calculates the sum of the load values of the components of 0 as the load value of the details setting screen 70.

Then, the operation load calculation unit 3 outputs the sum of the load values 28 (28+0) of the new creation screen 60 and the details setting screen 70 as the load value of the designated operation to the confirmation suitability determination unit 4.

The confirmation suitability determination unit 4 assumes the load value “28” of the operation output from the operation load calculation unit 3 as an index indicating an importance of an item to be confirmed by the confirmation dialog 52, and compares it with the predefined threshold “50.” Since the load value is less than the predefined threshold, the confirmation suitability determination unit 4 determines that the confirmation dialog 52 is displayed for the operation with a low importance and that it is problematic, and outputs the determination result to the input/output means 1. Thereafter, the input/output means 1 is controlled to display the determination result on the display device, for example.

As described above, in the present exemplary embodiment, in order to determine whether the confirmation dialog displayed in deleting data is unnecessary, the component information input unit 201 can designate component information such as a necessity of input, an operation frequency or a necessity of business knowledge per UI component configuring the operation (the group of screens) for recovering (re-inputting) the data. Then, the component information processing unit 301 corrects and calculates the load value of each UI component with reference to the designated component information. Thereby, in the present exemplary embodiment, a determination can be made as to evaluation of GUI usability according to the usage situation or business requirements.

In the present exemplary embodiment, the target operation designation unit 2 can designate the screen or GUI component used for the operation and determines suitability of the confirmation method with reference to the screen or GUI component according to an evaluator's operation, but the information for previously specifying an operation to be evaluated or the component information may be held and may be referred to by the operation load calculation unit 3 instead of the provision of the target operation designation unit 2.

As described above, by use of the GUI evaluation system according to the present exemplary embodiment, a load value on the user is calculated for the operation designated in units of screen or UI component by the evaluator with reference to the type or the number of screens or UI components used for the designated operation and the component information designated in units of UI component by the evaluator, and is assumed as an importance of the operation to determine whether the load value exceeds the predetermined threshold.

Consequently, a determination can be made as to whether to display an execution confirmation message on data deletion or optional operation cancellation with higher reliability according to the usage situation or business requirements. Even when the usage situation or business requirements are unclear, the evaluator inputs the component information in a graspable range thereby to obtain more reliable results as compared with the structure of the first exemplary embodiment.

### Third Exemplary Embodiment

A third exemplary embodiment of the present invention will be described below. The present exemplary embodiment is such that the target operation designation unit 2 comprises an operation frequency input unit 202 and the confirmation suitability determination unit 4 comprises a confirmation level determination unit 401 in addition to the structure of the first exemplary embodiment or the second exemplary embodiment.

The operation frequency input unit 202 comprises a function of, when the evaluator uses the input means 1 to input a frequency to execute a designated operation, outputting the input frequency as operation frequency information indicating an operation frequency according to an evaluator's operation.

The confirmation level determination unit 401 has a function of determining suitability of a level (such as presence or type of icon (such as “?” or “!”) and whether an initial state of a button focus is an execution button or cancellation button) on displaying the confirmation dialog with reference to the load value of the operation output from the operation load calculation unit 3 and the operation frequency information on the operation output from the operation frequency input unit 202.

FIG. 9 is a block diagram showing an exemplary GUI evaluation system structure according to the present exemplary embodiment. Only the constituents different from those in the second exemplary embodiment will be described below.

In order to evaluate GUI usability, the evaluator uses the input/output means 1 to designate an operation, and inputs a frequency to execute the operation.

The operation frequency input unit 202 adds a frequency to execute the designated operation together with the information on the designated operation, and outputs it as the operation frequency information to the confirmation suitability determination unit 4 according to an evaluator's operation.

The confirmation level determination unit 401 refers to the load value of the operation output from the operation load calculation unit 3 and the operation frequency information output from the operation frequency input unit 202. The confirmation level determination unit 401 finds a coordinate of the operation on a plane with the load value and the operation frequency as axes, and determines suitability of the confirmation level (such as presence or type of icon (such as “?” or “!”), and whether the initial state of the button focus is an execution button or cancel button) according to a predetermined range setting.

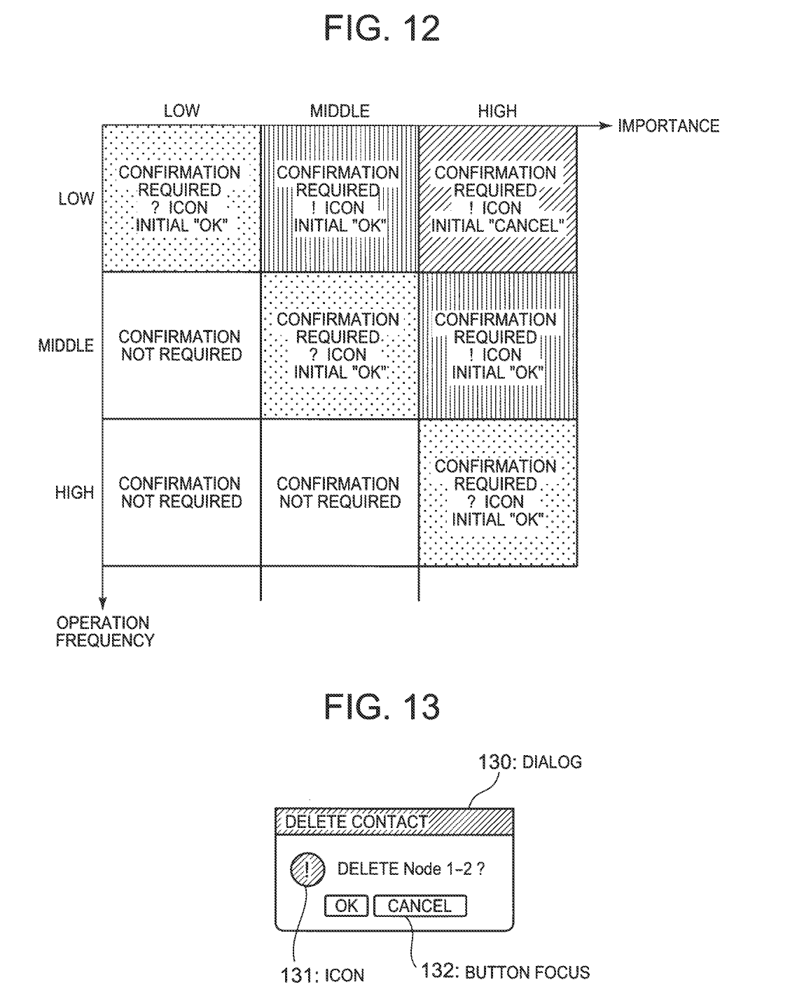

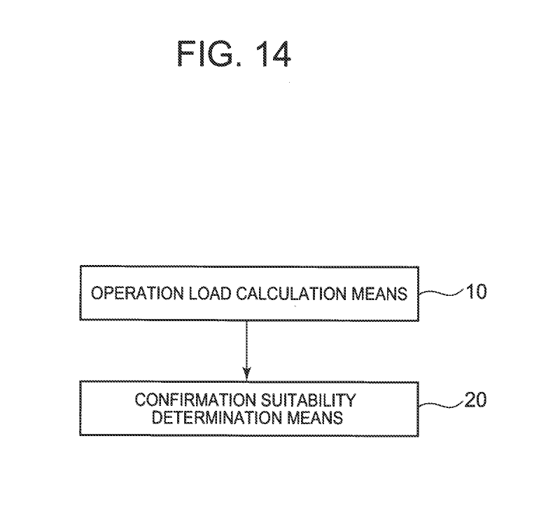

FIG. 12 is an explanatory diagram showing an exemplary determination map with an importance (load value) and an operation frequency held by the confirmation level determination unit 401. In the determination map shown in FIG. 12, when the load value of the operation is 50 or less, the importance is “low”, when the load value is between 50 and 100, the importance is “middle”, and when the load value is 100 or more, the importance is “high.” It is assumed that the evaluator determines the operation frequency by selecting and designating any of “high”, “middle” and “low.”

In the example shown in FIG. 12, when the importance is “high” and the operation frequency is “low”, for example, a confirmation dialog is displayed, and it is suitable that the icon of the “!” mark is arranged in the confirmation dialog and the button focus in the initial state is the “cancel” button.

In the determination map shown in FIG. 12, when both the importance and the operation frequency are “middle”, it is suitable that the icon of the “?” mark is arranged and the button focus in the initial state is an “OK” button. In the determination map shown in FIG. 12, when the importance is low and the operation frequency is high, it is suitable not to make a confirmation. When the importance is low and the operation frequency is high, for example, it is suitable not to display a confirmation dialog.

FIG. 13 is an explanatory diagram showing an exemplary confirmation dialog with the highest confirmation level. In a confirmation dialog 130 shown in FIG. 13, an icon 131 of the “!” mark is arranged and a button focus 132 in the initial state is assumed as a “cancel” button.

There will be described below, as an exemplary operation of the present exemplary embodiment, a flow in which a determination is made as to whether the confirmation level is suitable with reference to operation frequency information and a load value of an operation designated according to an evaluator's operation.

For the operation of deleting a node of the tree 50 shown in FIG. 5 introduced in the first exemplary embodiment, it is assumed that the evaluator uses the input/output means 1 to designate the operation frequency at “low.”

In the example shown in FIG. 5 according to the first exemplary embodiment, the load value of the operation is 138. The confirmation level determination unit 401 determines the importance as “high” since the load value of the designated operation is the predefined value of 100 or more.

The confirmation level determination unit 401 extracts, as a suitable confirmation level, confirmation required, use of icon “!” and “cancel” button as initial focus with reference to the determination map shown in FIG. 12 together with the operation frequency of “low.”

Then, since the confirmation dialog 33 used for the operation is different from the extracted suitable confirmation level (that is, the icon type and the initial focus are different), the confirmation level determination unit 401 determines as “problematic”, and outputs the determination result to the input/output means 1. Thereafter, the input/output means 1 is controlled to display the determination result on the display device, for example.

In the example shown in the second exemplary embodiment, the load value of the designated operation is 28. In this case, since the load value of the operation is the predetermined value of 50 or less, the confirmation level determination unit 401 determines the importance as “low.”

Then, the confirmation level determination unit 401 extracts, as a suitable confirmation level, confirmation required, use of icon “?” and “OK” button as initial focus with reference to the determination map of FIG. 12 together with the operation frequency of “low.”

Since the confirmation dialog 33 used for the operation matches with the extracted suitable confirmation level, the confirmation level determination unit 401 determines as “no problem” and outputs the determination result to the input/output means 1. Thereafter, the input/output means 1 is controlled to display the determination result on the display device, for example.

Consequently, the operation frequency of the operation can be designated by the evaluator, the usage frequency is considered in addition to the importance (load value), and the determination map for which a suitable confirmation level is changed is used, thereby more finely determining the suitability of the confirmation dialog.

As described above, the operation designated in units of screen or UI component by the evaluator can be designated according to the operation frequency of the designated operation by use of the GUI evaluation system according to the present exemplary embodiment. A suitable confirmation level is determined based on which predefined area the coordinate of the operation is contained in by use of both axes of the importance (load value) and the operation frequency of the operation with reference to both the designated operation frequency and the load value of the operation, thereby determining the suitability of the level of the confirmation dialog display.

Consequently, the suitability of the confirmation level can be determined finely and objectively, such as a presence of the display of the confirmation dialog, a presence or type of the icon for the confirmation dialog display, and a position of the initial focus button.

In the present exemplary embodiment, the operation frequency input unit 202 enables the operation frequency of the operation to be designated according to an evaluator's operation, and determines the confirmation level with reference to the operation frequency, but when an operation log of the user is previously held and analyzed data is provided, may refer to the operation log or the analyzed data.

The problems of a typical GUI evaluation method on which the present invention is based, and the solutions and effects of the problems of the present invention will be described. The typical GUI evaluation method has the following problems as a precondition of the present invention.

The first problem is that when a usage situation or business requirements of a system for which usability is to be evaluated are unclear, a determination cannot be objectively made as to whether a confirmation message is to be displayed (whether it is unnecessary). Even when the usage situation or business requirements of the system are clear, it is difficult to objectively determine whether the confirmation message is to be displayed.

This is because on a user's presumption of an importance of an operation for which a confirmation message is displayed, a determination that the confirmation message is to be displayed needs to be made when the importance is determined as being high, but an objective and common reference is not present as a threshold for the operation importance calculation method or a determination reference as to whether to display the confirmation message, and is defined at evaluator's discretion.

Further, even when the evaluator grasps the importance of the operation for which the confirmation message is displayed, a level of the importance is only roughly recognized as high or low, and a clear reference as to whether to display the confirmation message is not defined. Consequently, suitability of the determination depends on evaluator's discretion.

The second problem is that for the first problem, when a load value (importance) of a relevant operation is calculated only depending on a typical property of a UI component, the output load value is low in its reliability.

This is because a load on the user is influenced by a usage frequency when an input using each UI component is not mandatory or optional, or information on a necessity of some knowledge for input.

The third problem is that when a confirmation dialog is displayed, it is not possible to objectively determine suitability of a confirmation level determined based on a presence or type of icon (such as “?” or “!”) and whether an initial state of a button focus is an execution button or cancellation button.

This is because the evaluator needs to determine that the confirmation level is to be made higher when the importance is higher and the usage operation is lower in consideration of the importance and the operation frequency of the operation for which the confirmation dialog is displayed, but an objective and common reference is not present as a determination reference of the confirmation level using the importance or usage frequency of the operation, and is defined at evaluator's discretion.

In order to solve the problems, the GUI evaluation system according to the present invention comprises the following means.

The GUI evaluation system according to the present invention for solving the first problem includes the input/output means 1, the target operation designation unit 2, the operation load calculation unit 3, and the confirmation suitability determination unit 4.

The input/output means 1 comprises the input means which is achieved by an input device such as mouse or keyboard and is directed for inputting information according to an evaluator's operation, and the output means achieved by a display device.

The target operation designation unit 2 specifies an operation for which an importance is to be calculated as a set of screens or UI components based on the information input from the input/output means 1 according to an evaluator's operation, and outputs it as information on one operation to the operation load calculation unit 3.

The operation load calculation unit 3 extracts all the screens and UI components used for the operation with reference to the information on the operation output from the target operation designation unit 2, determines a load value of the UI component per UI component in each screen based on a type of the UI component (such as text box, list box and radio button) and a property of the UI component (such as the number of rows of the text box, a presence of a neighboring reference button, the number of items of the list box, and the number of options of the radio button), and calculates the sum of the load values of the UI components included in the screen as a load value of the screen.

Further, when multiple screens used for an operation are present and a hierarchy relationship is present among the screens, the operation load calculation unit 3 adds a predefined weight (or multiplies) to a load value of a screen in a deep hierarchy, calculates the sum of the load values of all the screens (or the UI components) used for the operation as a load value of the operation, and outputs it to the confirmation suitability determination unit 4.

The confirmation suitability determination unit 4 refers to the load value of the operation output from the operation load calculation unit 3, assumes it as an index indicating an importance of the operation, and when the importance does not exceed a predetermined threshold, determines that the display of the confirmation message is unnecessary (problematic), and outputs the determination result to the input/output means 1.

With the structure, a load of an operation on the user is calculated, based on a type or the number of screens or UI components used for the operation, for the operation designated by the evaluator in units of screen or in units of UI component, and is assumed as an importance of the operation to determine whether a predetermined threshold is exceeded, thereby solving the first problem.

The GUI evaluation system according to the present invention for solving the second problem is such that the target operation designation unit 2 includes the component information input unit 201 and the operation load calculation unit 3 includes the component information input unit 301 in addition to the GUI evaluation system according to the present invention for solving the first problem.

The component information input unit 201 adds information on a usage situation or business requirements such as a necessity of input, an operation frequency and a necessity of business knowledge on input to each UI component used for a designated operation based on the information input from the input/output means 1 according to an evaluator's operation, and outputs it as component information to the operation load calculation unit 3.

The component information processing unit 301 refers to the component information associated with each UI component output from the component information input unit 201, and calculates a load value of the UI component.

With the structure, the component information on the usage situation or business requirements designated by the evaluator for each UI component is referred to, and a load value of an operation on the user is calculated by the component information in addition to a type or the number of UI components used for the operation and is assumed as an importance of the operation to determine whether a predetermined threshold is exceeded, thereby solving the second problem.

The GUI evaluation system according to the present invention for solving the third problem is such that the target operation designation unit 2 includes the operation frequency input unit 202 and the confirmation suitability determination unit 4 includes the confirmation level determination unit 401 in addition to the GUI evaluation system according to the present invention for solving the first or second problem.

The operation frequency input unit 202 adds a frequency to execute a designated operation based on information input from the input/output means 1 according to an evaluator's operation, and outputs it as an operation frequency of the operation to the confirmation suitability determination unit 4.

The confirmation level determination unit 401 finds a coordinate of the operation on a plane with the axes of the load value and the operation frequency with reference to the load value of the operation output from the operation load calculation unit 3 and the operation frequency of the operation output from the operation frequency input unit 202, and determines suitability of a confirmation level in a predetermined range setting.

With the structure, the suitability of the confirmation level is determined based on which predefined area the coordinate of the operation is contained in by use of both axes of the importance (load value) of the operation and the operation frequency with reference to the operation frequency of the evaluator-designated operation together with the load value of the operation, thereby solving the third problem.

The means for solving the problems are provided and thus the GUI evaluation system according to the present invention has the following effects.

The first effect is that even when a usage situation or business requirements are unclear, a determination as to whether to display an execution confirmation message can be objectively made without evaluator's discretion on data deletion or optional operation cancellation.

This is because the operation for re-inputting data to be deleted for which a confirmation message is displayed, or an operation before the cancellation is designated as a group of screens or UI components by the evaluator, and thus a load of the operation on the user is calculated based on a type or the number of UI components or screens used for the operation and is assumed as an importance of the operation, thereby determining whether a predefined threshold is exceeded.

The second effect is that a load value can be calculated with higher reliability than the first effect.

This is because the evaluator designates the component information on the usage situation or business requirements for each UI component, calculates the load value of the operation on the user by use of the component information in addition to the type or the number of UI components used for the operation and assumes it as the importance of the operation, thereby determining whether the predetermined threshold is exceeded.

The third effect is that when a confirmation dialog is displayed, a determination can be objectively made as to whether a confirmation level (such as presence or type of icon (such as “?” or “!”), and whether an initial state of a button focus is an execution button or cancellation button) is suitable for operation contents.

This is because suitability of the confirmation level is can be determined based on which predefined area the coordinate of the operation is contained in by use of both axes of the importance (load value) of the operation and the operation frequency with reference to both the operation frequency of the operation designated by the evaluator and the load value of the operation and can be used as the determination reference.

In this way, in the GUI evaluation system according to the present invention, when data deletion is conducted or edition operation is interrupted, suitability for displaying a message for confirming executability can be evaluated.

The minimum structure of the GUI evaluation system according to the present invention will be described below. FIG. 13 is a block diagram showing an exemplary minimum structure of the GUI evaluation system. As shown in FIG. 13, the GUI evaluation system includes operation load calculation means 10 and confirmation suitability determination means 20 as minimum constituents.

In the GUI evaluation system with the minimum structure, the operation load calculation means 10 calculates a load value indicating a level of load of an operation based on attributes of UI components used for a GUI to be evaluated. The confirmation suitability determination means 20 determines suitability of a confirmation method related to the operation to be evaluated based on the load value calculated by the operation load calculation means 10.

Thus, according to the GUI evaluation system with the minimum structure, suitability for displaying a confirmation message or the like can be objectively determined based on a predetermined reference.

In the present exemplary embodiment, the characteristic structures of the GUI evaluation system will be described below in (1) to (10).

(1) A GUI evaluation system for evaluating GUI usability comprises operation load calculation means (achieved by the operation load calculation unit 3, for example) for calculating a load value indicating a level of load of an operation based on attributes (such as type or property) of UI components (such as text box or list box) used for a GUI (operation) to be evaluated, and confirmation suitability determination means (achieved by the confirmation suitability determination unit 4, for example) for determining suitability of a confirmation method related to the operation based on a load value calculated by the operation load calculation means.

(2) The GUI evaluation system may be configured such that the operation load calculation means calculates a load value of a UI component used for a GUI to be evaluated based on a type and a property of the UI component, and calculates the sum of the calculated load values of the UI components as a load value (importance, for example) of the operation, and when the load value of the operation calculated by the operation load calculation means exceeds a predetermined threshold, the confirmation suitability determination means determines that a confirmation method related to the operation is not suitable.

(3) The GUI evaluation system comprises operation load calculation means (achieved by the operation load calculation unit 3, for example) for determining a load value of a UI component per UI component used for an operation based on at least a type of the UI component and a property of the UI component with reference to evaluation target operation information including information for specifying at least a screen or UI component, assuming the sum of the load values of the UI components included in the screen as a load value of the screen, and calculating the sum of the load values of the screens or UI components used for the operation as a load value of the operation, and confirmation suitability determination means (achieved by the confirmation suitability determination unit 4, for example) for determining suitability of a confirmation method related to the operation based on the load value of the operation calculated by the operation load calculation means.

(4) The GUI evaluation system may be configured to include target operation designation means (achieved by the target operation designation unit 2, for example) for specifying an operation to be evaluated as a set of screens or UI components and outputting the specified set of screens or UI components as evaluation target operation information according to an evaluator's designation operation.

(5) The GUI evaluation system may be configured such that the confirmation suitability determination means uses a weight of operation contents (such as file deletion operation or edition operation cancellation) to calculate an importance of the operation for the load value calculated by the operation load calculation means, and determines suitability of a confirmation method related to the operation based on the calculated importance.

(6) The GUI evaluation system may be configured such that when multiple screens used for an operation are present and a hierarchy relationship is present among the screens, the operation load calculation means uses a weight (such as hierarchy weight) for the hierarchy relationship among the screens to calculate a load value.

(7) The GUI evaluation system may be configured such that the operation load calculation means includes component information processing means (such as the component information processing unit 301) for calculating a load value of a UI component based on component information in addition to at least a type of the UI component and a property of the UI component with reference to the component information on a necessity or frequency of an operation of each UI component used for the operation in addition to evaluation operation information.

(8) The GUI evaluation system may be configured such that the target operation designation means includes component information input means (such as the component information input unit 201) for adding information indicating a necessity or frequency of an operation to a UI component used for the designated operation and outputting it as component information according to an evaluator's designation operation.

(9) The GUI evaluation system may be configured such that the confirmation suitability determination means includes confirmation level determination means (such as the confirmation level determination unit 401) for determining suitability of a confirmation method related to the operation based on the load value of the operation calculated by the operation load calculation means and operation frequency information indicating an operation frequency of the operation.

(10) The GUI evaluation system may be configured such that the target operation designation means includes an operation frequency input means (such as the operation frequency input unit 202) for adding information indicating a frequency to execute an operation and outputting it as operation frequency information on the operation according to an evaluator's designation operation.

Part of or all the exemplary embodiments may be described as the Supplementary notes, but are not limited thereto.

(Supplementary note 1) A GUI evaluation system for evaluating GUI usability, comprising operation load calculation means for calculating a load value indicating a level of load of an operation based on attributes of UI components used for a GUI to be evaluated, and confirmation suitability determination means for determining suitability of a confirmation method related to the operation based on a load value calculated by the operation load calculation means.

(Supplementary note 2) The GUI evaluation system according to Supplementary note 1, wherein the operation load calculation means calculates a load value of a UI component used for a GUI to be evaluated based on a type and a property of the UI component, and calculates the sum of the calculated load values of the UI components as a load value of the operation, and when the load value of the operation calculated by the operation load calculation means exceeds a predetermined threshold, the confirmation suitability determination means determines that a confirmation method related to the operation is not suitable.

(Supplementary note 3) A GUI evaluation system comprising operation load calculation means for determining a load value of a UI component per UI component used for an operation based on at least a type of the UI component and a property of the UI component with reference to evaluation target operation information including information for specifying at least a screen or UI component, assuming the sum of the load values of the UI components included in the screen as a load value of the screen, and calculating the sum of the load values of the screens or UI components used for the operation as a load value of the operation, and confirmation suitability determination means for determining suitability of a confirmation method related to the operation based on the load value of the operation calculated by the operation load calculation means.

(Supplementary note 4) The GUI evaluation system according to Supplementary note 3, comprising target operation designation means for specifying an operation to be evaluated as a set of screens or UI components and outputting the specified set of screens or UI components as evaluation target operation information according to an evaluator's designation operation.

(Supplementary note 5) The GUI evaluation system according to Supplementary note 3 or Supplementary note 4, wherein the confirmation suitability determination means uses a weight of operation contents to calculate an importance of the operation for the load value calculated by the operation load calculation means, and determines suitability of a confirmation method related to the operation based on the calculated importance.

(Supplementary note 6) The GUI evaluation system according to any one of Supplementary note 3 to Supplementary note 5, wherein when multiple screens used for an operation are present and a hierarchy relationship is present among the screens, the operation load calculation means uses a weight for the hierarchy relationship among the screens to calculate a load value.

(Supplementary note 7) The GUI evaluation system according to any one of Supplementary note 3 to Supplementary note 6, wherein the operation load calculation means includes component information processing means for calculating a load value of a UI component based on component information in addition to at least a type of the UI component and a property of the UI component with reference to the component information on a necessity or frequency of an operation of each UI component used for the operation in addition to evaluation operation information.

(Supplementary note 8) The GUI evaluation system according to Supplementary note 7, wherein the target operation designation means includes component information input means for adding information indicating a necessity or frequency of an operation to a UI component used for the designated operation and outputting it as component information according to an evaluator's designation operation.

(Supplementary note 9) The GUI evaluation system according to Supplementary note 3 to Supplementary note 8, wherein the confirmation suitability determination means includes confirmation level determination means for determining suitability of a confirmation method related to the operation based on the load value of the operation calculated by the operation load calculation means and operation frequency information indicating an operation frequency of the operation.

(Supplementary note 10) The GUI evaluation system according to Supplementary note 9, wherein the target operation designation means includes operation frequency input means for adding information indicating a frequency to execute an operation and outputting it as operation frequency information on the operation according to an evaluator's designation operation.

(Supplementary note 11) A GUI evaluation method for evaluating GUI usability, comprising: calculating a load value indicating a level of load of an operation based on attributes of UI components used for a GUI to be evaluated, and determining suitability of a confirmation method related to the operation based on the calculated value.

(Supplementary note 12) The GUI evaluation method according to Supplementary note 11, comprising: calculating a load value of a UI component used for a GUI to be evaluated based on a type and a property of the UI component, and calculating the sum of calculated load values of the UI components as a load value of the GUI, and when the calculated load value of the operation exceeds a predetermined threshold, determining that a confirmation method related to the operation is not suitable.

(Supplementary note 13) A GUI evaluation method comprising: determining a load value of a UI component per UI component used for an operation based on at least a type of the UI component and a property of the UI component with reference to evaluation target operation information including information for specifying at least a screen or UI component, assuming the sum of the load values of the UI components included in the screen as a load value of the screen, and calculating the sum of the load values of the screens or UI components used for the operation as a load value of the operation, and determining suitability of a confirmation method related to the operation based on the calculated load value of the operation.

(Supplementary note 14) The GUI evaluation method according to Supplementary note 13, comprising: specifying an operation to be evaluated as a set of screens or UI components and assuming it as evaluation target operation information according to an evaluator's designation operation.

(Supplementary note 15) The GUI evaluation method according to Supplementary note 13 or Supplementary note 14, comprising calculating an importance of an operation by use of a weight of operation contents for a load value of the operation, and determining suitability of a confirmation method related to the operation based on the calculated importance.

(Supplementary note 16) The GUI evaluation method according to any one of Supplementary note 13 to Supplementary note 15, comprising, when multiple screens used for an operation are present and a hierarchy relationship is present among the screens, calculating a load value of an operation by use of a weight of the hierarchy relationship among the screens.

(Supplementary note 17) The GUI evaluation method according to any one of Supplementary note 13 to Supplementary note 16, comprising calculating a load value of a UI component based on component information in addition to at least a type of a UI component and a property of the UI component with reference to the component information on a necessity or frequency of an operation of each UI component used for the operation in addition to evaluation operation information.

(Supplementary note 18) The GUI evaluation method according to Supplementary note 17, comprising adding information on a necessity or frequency of an operation to a UI component used for a designated operation and assuming it as component information according to an evaluator's designation operation.

(Supplementary note 19) The GUI evaluation method according to any one of Supplementary note 13 to Supplementary note 18, comprising determining suitability of a confirmation method related to an operation based on a load value of the operation and operation frequency information indicating an operation frequency of the operation.

(Supplementary note 20) The GUI evaluation method according to Supplementary note 19, comprising adding information indicating a frequency to execute an operation and assuming it as operation frequency information on the operation according to an evaluator's designation operation.

(Supplementary note 21) A GUI evaluation program for evaluating GUI usability, which causes a computer to execute an operation load calculation processing of calculating a load value indicating a level of load of an operation based on attributes of UI components used for a GUI to be evaluated, and a confirmation suitability determination processing of determining suitability of a confirmation method related to the operation based on the calculated load value.

(Supplementary note 22) The GUI evaluation program according to Supplementary note 21, which causes a computer to execute a processing of calculating a load value of a UI component used for a GUI to be evaluated based on a type and a property of the UI component and calculating the sum of the calculated load values of the UI components as a load value of the operation in the operation load calculation processing, and a processing of, when the calculated load value of the operation exceeds a predetermined threshold, determining that a confirmation method related to the operation is not suitable in the confirmation suitability determination processing.

(Supplementary note 23) A GUI evaluation program for causing a computer to execute an operation load calculation processing of determining a load value of a UI component per UI component used for an operation based on at least a type of the UI component and a property of the UI component with reference to evaluation target operation information including information for specifying at least a screen or UI component, assuming the sum of the load values of the UI components included in the screen as a load value of the screen, and calculating the sum of the load values of the screens or UI components used for the operation as a load value of the operation, and a confirmation suitability determination processing of determining suitability of a confirmation method related to the operation based on the calculated load value.

(Supplementary note 24) The GUI evaluation program according to Supplementary note 23, which causes a computer to execute a target operation designation processing of specifying an operation to be evaluated as a set of screens or UI components and assuming it as evaluation target operation information according to an evaluator's designation operation.

(Supplementary note 25) The GUI evaluation program according to Supplementary note 23 or Supplementary note 24, which causes a computer to execute a processing of calculating an importance of an operation by use of a weight of operation contents for a load value of the operation, and determining suitability of a confirmation method related to the operation based on the calculated importance in the confirmation suitability determination processing.

(Supplementary note 26) The GUI evaluation program according to any one of Supplementary note 23 to Supplementary note 25, which causes a computer to execute a processing of, when multiple screens used for an operation are present and a hierarchy relationship is present among the screens, calculating a load value by use of a weight of the hierarchy relationship among the screens in the operation load calculation processing.

(Supplementary note 27) The GUI evaluation program according to anyone of Supplementary note 23 to Supplementary note 26, which causes a computer to execute a processing of calculating a load value of a UI component based on component information in addition to at least a type of the UI component and a property of the UI component with reference to the component information on a necessity or frequency of an operation of each UI component used for an operation in addition to evaluation operation information in the operation load calculation processing.

(Supplementary note 28) The GUI evaluation program according to Supplementary note 27, which causes a computer to execute a processing of adding information on a necessity or frequency of an operation to a UI component used for a designated operation and assuming it as component information according to an evaluator's designation operation in the target operation designation processing.

(Supplementary note 29) The GUI evaluation program according to any one of Supplementary note 23 to Supplementary note 28, which causes a computer to execute a processing of determining suitability of a confirmation method related to an operation based on a load value of the operation and operation frequency information indicating an operation frequency of the operation in the confirmation suitability determination processing.

(Supplementary note 30) The GUI evaluation program according to Supplementary note 29, which causes a computer to execute a processing of adding information indicating a frequency to execute an operation and assuming it as operation frequency information on the operation according to an evaluator's designation operation in the target operation designation processing.

The present invention has been described above with reference to the exemplary embodiments and the examples, but the present invention is not limited to the exemplary embodiments. It is understood by those skilled in the art that various modifications may be made to the structure or details of the present invention within the scope of the present invention.

This application claims the priority based on Japanese Patent Application 2009-200721 filed on Aug. 31, 2009, the disclosure of which is all incorporated herein.

### INDUSTRIAL APPLICABILITY

The present invention is applicable for calculating a user load on a designated operation (group of screens or UI components), assuming it as an importance of the designated operation, and thereby evaluating suitability of a presence or level of a confirmation on operation execution, for all operations for which system usability is evaluated on a computer.

### REFERENCE SIGNS LIST

1 Input/output means
2 Target operation designation unit
3 Operation load calculation unit
4 Confirmation suitability determination unit
10 Operation load calculation means
20 Confirmation suitability determination means
201 Component information input unit
202 Operation frequency input unit
301 Component information processing unit
401 Confirmation level determination unit

1-30. (canceled)

31. A GUI evaluation system for evaluating GUI usability, comprising:
an operation load calculation unit which calculates a load value indicating a level of load of an operation based on attributes of UI components used for a GUI to be evaluated; and
a confirmation suitability determination unit which determines suitability of a confirmation method related to the operation based on a load value calculated by the operation load calculation unit.

32. The GUI evaluation system according to claim 31, wherein the operation load calculation unit calculates a load value of a UI component used for a GUI to be evaluated based on a type and a property of the UI component, and calculates the sum of the calculated load values of the UI components as a load value of the operation, and
when the load value of the operation calculated by the operation load calculation unit exceeds a predetermined threshold, the confirmation suitability determination unit determines that a confirmation method related to the operation is not suitable.

53. A GUI evaluation system comprising:
an operation load calculation unit which determines a load value of a UI component per UI component used for an operation based on at least a type of the UI component and a property of the UI component with reference to evaluation target operation information including information for specifying at least a screen or UI component, assuming the sum of the load values of the UI components included in the screen as a load value of the screen, and calculating the sum of the load values of the screens or UI components used for the operation as a load value of the operation; and
a confirmation suitability determination unit which determines suitability of a confirmation method related to the operation based on the load value of the operation calculated by the operation load calculation unit.

34. The GUI evaluation system according to claim 33, comprising a target operation designation unit which specifies an operation to be evaluated as a set of screens or UI components and outputting the specified set of screens or UI components as evaluation target operation information according to an evaluator's designation operation.

35. The GUI evaluation system according to claim 33, wherein the confirmation suitability determination unit uses a weight of operation contents to calculate an importance of the operation for the load value calculated by the operation load calculation unit, and determines suitability of a confirmation method related to the operation based on the calculated importance.

36. The GUI evaluation system according to claim 33, wherein when multiple screens used for an operation are present and a hierarchy relationship is present among the screens, the operation load calculation unit uses a weight for the hierarchy relationship among the screens to calculate a load value.

37. The GUI evaluation system according to claim 33, wherein the operation load calculation unit includes a component information processing unit which calculates a load value of a UI component based on component information in addition to at least a type of the UI component and a property of the UI component with reference to the component information on a necessity or frequency of an operation of each UI component used for the operation in addition to evaluation operation information including information for specifying at least a screen or UI component.

38. The GUI evaluation system according to claim 34, wherein the target operation designation unit includes a component information input unit which adds information indicating a necessity or frequency of an operation to a UI component used for the designated operation and outputting it as component information according to an evaluator's designation operation.

39. The GUI evaluation system according to claim 33, wherein the confirmation suitability determination unit includes a confirmation level determination unit which determines suitability of a confirmation method related to the operation based on the load value of the operation calculated by the operation load calculation unit and operation frequency information indicating an operation frequency of the operation.

40. The GUI evaluation system according to claim 34 wherein the target operation designation unit includes an operation frequency input unit which adds information indicating a frequency to execute an operation and outputting it as operation frequency information on the operation according to an evaluator's designation operation.

41. A GUI evaluation method for evaluating GUI usability, comprising:
calculating a load value indicating a level of load of an operation based on attributes of UI components used for a GUI to be evaluated; and
determining suitability of a confirmation method related to the operation based on the calculated value.

42. The GUI evaluation method according to claim 41, comprising:
calculating a load value of a UI component used for a GUI to be evaluated based on a type and a property of the UI component, and calculating the sum of calculated load values of the UI components as a load value of the GUI; and
when the calculated load value of the operation exceeds a predetermined threshold, determining that a confirmation method related to the operation is not suitable.

43. A GUI evaluation method comprising:
determining a load value of a UI component per UI component used for an operation based on at least a type of the UI component and a property of the UI component with reference to evaluation target operation information including information for specifying at least a screen or UI component, assuming the sum of the load values of the UI components included in the screen as a load value of the screen, and calculating the sum of the load values of the screens or UI components used for the operation as a load value of the operation; and
determining suitability of a confirmation method related to the operation based on the calculated load value of the operation.

44. The GUI evaluation method according to claim 43, comprising:
specifying an operation to be evaluated as a set of screens or UI components and assuming it as evaluation target operation information according to an evaluator's designation operation.

45. The GUI evaluation method according to claim 43, comprising:
calculating an importance of an operation by use of a weight of operation contents for a load value of the operation, and determining suitability of a confirmation method related to the operation based on the calculated importance.

46. The GUI evaluation method according to claim 43, comprising:
when multiple screens used for an operation are present and a hierarchy relationship is present among the screens, calculating a load value of an operation by use of a weight of the hierarchy relationship among the screens.

47. The GUI evaluation method according to claim 43, comprising:
calculating a load value of a UI component based on component information in addition to at least a type of a UI component and a property of the UI component with reference to the component information on a necessity or frequency of an operation of each UI component used for the operation in addition to evaluation operation information including information for specifying at least a screen or UI component.

48. The GUI evaluation method according to claim 47, comprising:
adding information on a necessity or frequency of an operation to a UI component used for a designated operation and assuming it as component information according to an evaluator's designation operation.

49. The GUI evaluation method according to claim 43, comprising:
determining suitability of a confirmation method related to an operation based on a load value of the operation and operation frequency information indicating an operation frequency of the operation.

50. The GUI evaluation method according to claim 49, comprising:
adding information indicating a frequency to execute an operation and assuming it as operation frequency information on the operation according to an evaluator's designation operation.

51. A computer readable information recording medium storing a program which, when executed by a processor, performs a method comprising:
calculating a load value indicating a level of load of an operation based on attributes of UI components used for a GUI to be evaluated; and
determining suitability of a confirmation method related to the operation based on the calculated load value.

52. The computer readable information recording medium according to claim 51,
calculating a load value of a UI component used for a GUI to be evaluated based on a type and a property of the UI component and calculating the sum of the calculated load values of the UI components as a load value of the operation when calculating the operation load; and
In case the calculated load value of the operation exceeds a predetermined threshold, determining that a confirmation method related to the operation is not suitable when determining the confirmation suitability.

53. A computer readable information recording medium storing a program which, when executed by a processor, performs a method comprising:
determining a load value of a UI component per UI component used for an operation based on at least a type of the UI component and a property of the UI component with reference to evaluation target operation information including information for specifying at least a screen or UI component, assuming the sum of the load values of the UI components included in the screen as a load value of the screen, and calculating the sum of the load values of the screens or UI components used for the operation as a load value of the operation; and
determining suitability of a confirmation method related to the operation based on the calculated load value.

54. The computer readable information recording medium according to claim 53, further comprising: specifying an operation to be evaluated as a set of screens or UI components and assuming it as evaluation target operation information according to an evaluator's designation operation.

55. The computer readable information recording medium according to claim 53,
calculating an importance of an operation by use of a weight of operation contents for a load value of the operation, and determining suitability of a confirmation method related to the operation based on the calculated importance when determining the confirmation suitability.

56. The computer readable information recording medium according to claim 53,
In case multiple screens used for an operation are present and a hierarchy relationship is present among the screens, calculating a load value by use of a weight of the hierarchy relationship among the screens when calculating the operation load.

57. The computer readable information recording medium according to claim 53,
calculating a load value of a UI component based on component information in addition to at least a type of the UI component and a property of the UI component with reference to the component information on a necessity or frequency of an operation of each UI component used for an operation in addition to evaluation operation information including information for specifying at least a screen or UI component, when calculating the operation load.

58. The computer readable information recording medium according to claim 54,
adding information on a necessity or frequency of an operation to a UI component used for a designated operation and assuming it as component information according to an evaluator's designation operation when designating the target operation.

59. The computer readable information recording medium according to claim 53,
determining suitability of a confirmation method related to an operation based on a load value of the operation and operation frequency information indicating an operation frequency of the operation when determining the confirmation suitability.

60. The computer readable information recording medium according to claim 54,
a processing of adding information indicating a frequency to execute an operation and assuming it as operation frequency information on the operation according to an evaluator's designation operation when designating the target operation.
